(19) United States
(12) Patent Application Publication
(10) Pub. No.: US 2006/0281525 A1
(43) Pub. Date: Dec. 14, 2006

(54) Slot type game with player input opportunity

(76) Inventor: Milo Borissov, Sharjah Al Durah Tower (AE)

Correspondence Address: WEIDE & MILLER, LTD., 7251 W. LAKE MEAD BLVD., SUITE 530, LAS VEGAS, NV, 89128, US

(21) Appl. No.: 11/131,918

(22) Filed: May 17, 2005

(51) Int. Cl. A63F 13/00

(52) U.S. Cl. 463/20

(57) ABSTRACT

In accordance with a slot-type game, symbols are generated and displayed, preferably in a plurality of reel-type columns. Upon the occurrence of a triggering event preferably comprising receipt of a special symbol in each of a first and second column of the symbols, the player is provided an input opportunity. The symbols in the columns containing the special symbols are treated as wild. The player is provided the opportunity to keep or move/change the symbols of the remaining columns, such as by moving the symbols of a particular column up or down by one or more discrete positions, or by randomly replacing the symbols of a column by “respinning.” A player may be provided a second such opportunity including the opportunity to move/change the symbols back to their original state, in an attempt to form one or more winning combinations of symbols.

### FIELD OF THE INVENTION

The present invention relates to casino-style slot type games.

### BACKGROUND OF THE INVENTION

Slot-type gaming machines are well-known and have been popular for years. These games have their origin in old mechanical spinning reel games where a player attempted to receive certain combinations of symbols as a result of the spin of the reels. More recently, these games have been implemented on video gaming machines where the symbols are generated and displayed on a video display.

The problem with these games is that the basic configuration of the game is relatively simple, and the game offers little player interaction. In particular, in accordance with these games, a set of symbols are randomly generated and are displayed. The outcome of the game is dependent upon the combination of displayed symbols. In this configuration, the only player input comprises the player's placing a wager and pressing a “spin” button or pulling a handle or arm which starts the game, causing the display of the symbols.

In order to make these games exciting, gaming manufacturers have recently begun offering “themed” slot type games. For example, popular themed gaming machines currently include Playboy®, Star Wars® and others. Associating a “theme” with the game does not, however, generally change the method of game play or the minimal player interaction offered thereby.

A slot-type game which provides a higher level of player excitement and interaction is desired.

### SUMMARY OF THE INVENTION

The present invention comprises a method of playing a game and a gaming machine configured to present a game. One embodiment of the invention is a slot-type game providing, at one or more times, opportunity for player input.

In accordance with one method of playing a game, a plurality of symbols are generated and displayed to a player. In a preferred embodiment, the symbols are associated with positions of a plurality of reels, such mechanical reels or simulated video reels. In this arrangement, the symbols are arranged into number of reel columns, each column having one or more rows of symbol positions.

The symbols are evaluated to determine if any predetermined winning combinations of symbols are displayed. If so, a winning result is declared. In one embodiment, only symbols along active paylines are evaluated to determine if winning combinations exist.

The symbols are also evaluated to determine if one or more special symbols are present. In one embodiment, if at least one special symbol is displayed in at least the first column (or reel), or the first and second columns (or reels), then a player input event is triggered.

In such instance, in a preferred embodiment, all symbols in each column/reel containing a special symbol is treated as “wild” (i.e. may be considered any symbol). A player is then provided the opportunity to provide input regarding one or more symbols to change, such as by movement or replacement.

In one embodiment, a player may maintain or keep the non-wild symbols, or is permitted to move the symbols of a particular reel or column up or down by one or more discrete positions (by providing input(s) regarding such selections). In another preferred embodiment, the player may maintain or keep the non-wild symbols, or may “respin” one or more of the remaining reels (i.e. reels not containing “wild” symbols), thus effecting random replacement of the symbols displayed as part of those reels.

The resulting symbols, including the “wild” symbols, are then evaluated to determine if they contain one or more winning combinations of symbols.

In a preferred variation of the game, a player is provided at least one second or subsequent opportunity to change the symbols after the first input. In an embodiment where the player may request discrete movement of the symbols of each reel/column up or down, at the second such opportunity the player may request that the symbols of each column maintain their position, return to their original position (if previously moved), or move up or down by one or more discrete positions. In an embodiment where the player may request respinning of the reels, at the second such opportunity the player may request that the symbols of each column maintain their position, return to their original position (if previously moved), or respin. If more than one sequential input opportunity is provided, the outcome of the game is determined after all such opportunities have been exhausted.

In a preferred embodiment, the game is played as a wagering game. A player places a wager for the opportunity to be awarded winnings (such as credits or monies) for winning game results. In one embodiment, the size of a player's wager determines the number of paylines which are activated.

In accordance with the invention, a slot-type game is provided which, at one or more times provides a player an input opportunity. In particular, a player is provided the opportunity to attempt to change one or more symbols (by movement/replacement) in an attempt to form one or more winning symbol combinations. In the preferred embodiment, various of the symbols are treated as “wild,” reducing the number of symbols which the player must align to obtain a winning combination.

One embodiment of the invention is a gaming machine configured to present a game of the invention.

Further objects, features, and advantages of the present invention over the prior art will become apparent from the detailed description of the drawings which follows, when considered with the attached figures.

### DESCRIPTION OF THE DRAWINGS

FIG. 1 illustrates a gaming device of the type which may be used to implement a game in accordance with the invention for play by a player;

FIG. 2 illustrates an example set of symbols displayed as part of play of a game in accordance with an embodiment of the invention;

FIG. 3 illustrates a second set of symbols representing an outcome of a game after a position of one or more of the symbols illustrated in FIG. 2 have been changed;

FIG. 4 illustrates a second set of symbols representing an outcome of a game after one or more reels of the symbols displayed in FIG. 2 have been respun;

FIG. 5 illustrates a first set of symbols displayed as part of play of a game in accordance with another embodiment of the invention;

FIG. 6 illustrates a second set of symbols after a player has provided input and a number of the symbols in said first set of symbols illustrated in FIG. 5 have been replaced;

FIG. 7 illustrates a third set of symbols representing an outcome of a game after a player has provided a second input and a number of the symbols in said second set of symbols illustrated in FIG. 6 have been replaced;

FIG. 8 illustrates a first set of symbols displayed as part of play of a game in accordance with another embodiment of the invention;

FIG. 9 illustrates a second set of symbols after a player has provided input and a number of the symbols in said first set of symbols illustrated in FIG. 8 have been moved;

FIG. 10 illustrates a third set of symbols representing an outcome of a game after a player has provided a second input and a number of the symbols in said second set of symbols illustrated in FIG. 9 have been moved;

FIG. 11 illustrates a game format for a game in accordance with another embodiment of the invention;

FIG. 12 illustrates an example payline configuration for a game in accordance with the present invention; and

FIG. 13 illustrates examples of various winning outcomes in accordance with a game of the invention.

### DETAILED DESCRIPTION OF THE INVENTION

The invention is a method of presenting and playing a game and a gaming machine/system configured to present a game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention comprises a method of presenting and/or playing a game in which a plurality of symbols are displayed. The game is a “slot” type game in which a player attempts to receive certain combinations of slot symbols. In accordance with the invention, the player is at one or more times offered or afforded the opportunity to provide input in an attempt to obtain a winning combination of symbols. In particular, a preferred embodiment, upon the display of a particular combination of symbols in particular positions, the player is afforded the opportunity to change other symbols or the position of symbols in an attempt to obtain a winning combination of symbols.

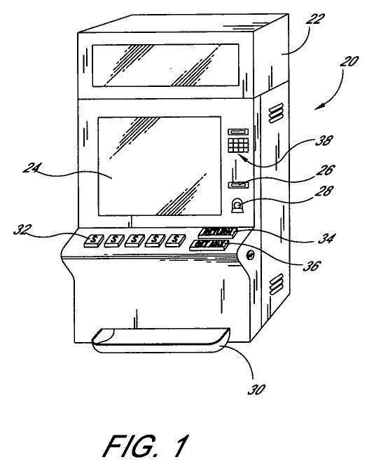

In a preferred embodiment, the game of the invention is presented to a player with a gaming machine. FIG. 1 illustrates one embodiment of a gaming machine 20 in accordance with the invention. As illustrated, the gaming machine 20 includes a housing 22 for enclosing/supporting various components of the gaming machine. The housing 22 have a variety of configurations. In one embodiment, the housing 22 is configured to the machine has an “upright” configuration. The machine 20 might also be configured as a “slant”-type, “bar-top” or have other forms.

In one embodiment, the gaming machine 20 is configured as a “video” type gaming machine, the machine including at least one display 24 for displaying game information to a player. As described below, this game information may include playing card and non-playing card symbols or indicia.

The gaming machine 20 may include other means for providing information to a player. For example, speakers (not shown) or other devices may be provided for generating sound associated with the game. The gaming machine 20 may also include lights, printed instructions and other displays/display devices.

In one embodiment, a player must make payment in order to be entitled to play the game. Preferably, the game is presented as a wagering type game, and a player must place a bet or wager in order to play the game for the opportunity to receive winnings. Preferably, if the player is a winner of the game, the player is provided an award, such as a monetary payout (such as coins), credits representing monetary value, points or tangible prizes. As illustrated, the gaming machine 20 may include a bill validator/acceptor 26 for accepting paper currency and a coin acceptor 28 for accepting coins. Other means of payment, such as a credit card reader, may be provided. An award of winnings in the form of coins may be paid to the player via a coin tray 30.

Preferably, the gaming machine 20 includes means for a player to provide input. In one embodiment, this means comprises one or more buttons. For example, a plurality of reel “spin” or move buttons 32 may be provided for permitting a player to provide symbol movement/replacement instructions (as described in more detail below). A bet one button 34 and bet max button 36 are provided for a player to select the amount to bet on a particular game. Other means of input may be provided, such as a touch-screen display and other devices now known or later developed.

A game controller (not shown) is provided for controlling the various devices of the gaming machine and for providing game information. For example, the game controller may be arranged to generate video and audio data for presentation by the display and speakers of the gaming machine 20. The game controller may be arranged to detect a signal from the coin acceptor indicating the receipt of coins or from the bill validator regarding accepted bills and for registering credits corresponding to those inputs, for subtracting credits for wagers placed by a player, and for causing a coin delivery mechanism to deliver coins from a coin hopper to the coin tray 30 for payment of winnings and/or return to a player of unwagered credits. Preferably, the one or more player input devices provide an output to the gaming controller for use in play of the game. For example, in response to a “bet one” input by a player, the gaming controller is preferably transmitted a signal which causes the gaming controller to initiate presentation of the game.

It will be appreciated that the gaming machine 20 may have a variety of configurations, and that the gaming machine 20 illustrated and described above is but an example of a device for implementing the game of the present invention. For example, in one or more embodiments, the gaming machine 20 may be associated with a network and receive game information remotely and may transmit information, such as payout and game play information, to a remote location. For example, a remote master controller may generate game information which is transmitted over a communication link to the gaming machine 20. That information may be utilized by a local controller or processor to present the game, such as by displaying game play data or information.

As indicated, in one embodiment, game information is displayed by a video display 24 to a player. That display may be of a variety of types, including CRT, LCD, plasma and others. The gaming machine 20 may also include more than one video display.

In one embodiment, as described in more detail below, game information which is presented to a player comprises simulated reels displaying game symbols. As indicated, these symbols may be displayed in graphical representation by the display.

In another embodiment, the gaming machine 20 may include one or more physical reels capable of displaying symbols. In such a configuration, means are provided for rotating the physical reels. In one or more embodiments, the means may comprise a mechanical linkage associated with a spin arm, with movement of the spin arm (a “pull”) by a user causing the reels to spin. In such an arrangement, the reels are generally allowed to free-wheel and then stop. In another embodiment, electronically controlled mechanisms are arranged to rotate and stop each reel. Such mechanisms are well known to those of skill in the art. In this arrangement, actuation of the spin arm or depression a spin button causes a controller (not shown) to signal the activation of the spin mechanism associated with one or more of the reels. Preferably, the controller is arranged to either turn off the signal to the device(s) effecting the rotation of each or all of the reels or generates a signal for activating a braking device, whereby the reels are stopped. As is well known, the combinations of reel positions and their odds of hitting are associated with the controller, and the controller is arranged to stop the reels in a position displaying a combination of indicia as determined by the controller based on the combinations and odds. The principal of such an arrangement is described in U.S. Pat. No. 4,448,419 to Telnaes, which is incorporated herein by reference.

The gaming machine 20 may have other configurations, including other features. For example, the gaming machine 20 may include a player tracking device 38, such as a card reader and associated keypad. Such player tracking devices are well known and may permit the game operator to track play of players of the gaming machine. The tracked play may be utilized to offer player bonuses or awards.

In one embodiment, the gaming machine 20 may be configured to dispense media, such as printed paper tickets, which have associated value. For example, winnings or unused credits may be returned to the player via a printed ticket having value or associated value. In one embodiment, the gaming machine 20 might also be configured to accept such media for providing credit for game play. Such systems are well known and thus not described in detail herein.

In one embodiment, the games of the invention are played as wagering type games in which a player must place a wager in order to play the game for an opportunity of winnings. In other embodiments, the game may be played for fun or prizes. In such event, the player may be permitted to play the game for free or may be required to make payment to play the game.

As indicated above, a player may provide value to the gaming machine 20 or machine operator in a number of ways, including with coins or bills. The player might also be permitted to provide value remotely.

Once the player provides value, the player preferably places a wager to play the game. This may be accomplished, in one embodiment, by the player pressing the “bet one” button 34 or the “bet max” button 36, or by other means.

Preferably, in response to the player placing a wager (or other or additional input, such as player input to a “spin” button or rotation of a handle or arm), a plurality of symbols or indicia are displayed to the player. In one embodiment, the controller of the gaming machine 20 is configured to randomly select or generate the symbols which are to be displayed. Such methods of generation/selection are well known and may include the generation of random numbers which correspond to symbols which are to be displayed.

The symbols are displayed to the player. In one embodiment, display of the symbols is via the video display 24. As indicated above, in another embodiment, the display of the symbols could be by one or more physical devices, such as physical reels, or a combination of physical reels and virtual reels displayed by a display.

Preferably, the outcome of the game is dependent upon the symbols which are generated and displayed to the player. In particular, certain combinations of symbols preferably comprise pre-determined winning combinations of symbols. Other combinations of symbols are losing combinations.

As detailed below, the symbols may be displayed in a variety of formats or arrangements. In an embodiment of the invention where the symbols are displayed by a video display, the symbols are preferably displayed in a plurality of reel-type columns similar to the manner symbols are displayed by physical rotatable reels in well-known slot machines. In such a configuration, each column may display a plurality of symbols. In one common configuration, five (5) columns of three (3) symbols, thus comprising a three (3) by five (5) matrix of symbols (such as representative of five reels each displaying three positions of symbols), are displayed. The symbols could be displayed in a variety of other configurations, such as in positions of a square matrix, a pyramid or other patterns.

An outcome of the game is determined by or from the combination of symbols which is generated and/or displayed. In one embodiment, one or more combinations of symbols are declared “winning” combinations. Those combinations may be referred to as “predetermined winning combinations,” since it is predetermined that those combinations, if generated as a result of game play, comprise winning combinations.

In one embodiment, it is determined if the generated symbols comprise any predetermined winning combination(s) of symbols. In a preferred embodiment, this determination is made, in at least one instance, with respect to symbols appearing along paylines and, preferably, active paylines.

In one embodiment, the generated symbols are displayed with reference to one or more paylines. Preferably, paylines define groups of two or more symbol locations. In one embodiment, the symbols may be displayed in a matrix format. In such instance, the paylines may be linear or non-linear. For example, the paylines may be common straight horizontal lines, or may be vertical, diagonal, “V” or other shapes/configurations. Preferably, however, one or more symbols are displayed with reference to one or more of the paylines.

In one embodiment, the size of a player's wager determines the number of paylines which are activated. A minimum wager may activate one or more paylines, while larger wagers than the minimum may activate additional or all of the paylines. For example, there may be five (5) paylines and the player may be permitted to place a wager of one (1) to five (5) credits. In such a configuration, one (1) payline may be activated for each credit which is wagered. Thus, all five (5) paylines would only be activated in the event the player wagered a five (5) credit wager.

In one embodiment of a game, if the set of displayed symbols includes one or more predetermined winning combinations of symbols, a winning outcome is declared. Further, if one or more special symbols are displayed, the player is preferably provided the opportunity to change (such as by moving or replacing) one or more of the other displayed symbols in an attempt to create one or more winning symbol combinations. In a preferred embodiment, if the special symbols are displayed on one or more of the reels, then the symbols on or associated with those reels/columns become wild and the player has the opportunity to replace or change the symbols on the other reels in an attempt for form winning combinations of symbols including the “wild” symbols. One embodiment of the invention is thus a game where a special set of symbols result in a “base” of wild symbols and which provides a player the opportunity to try, in conjunction with those “wild” symbols, to create a winning set of symbols, the game in one embodiment thus referred to as the “Win Builder” game.

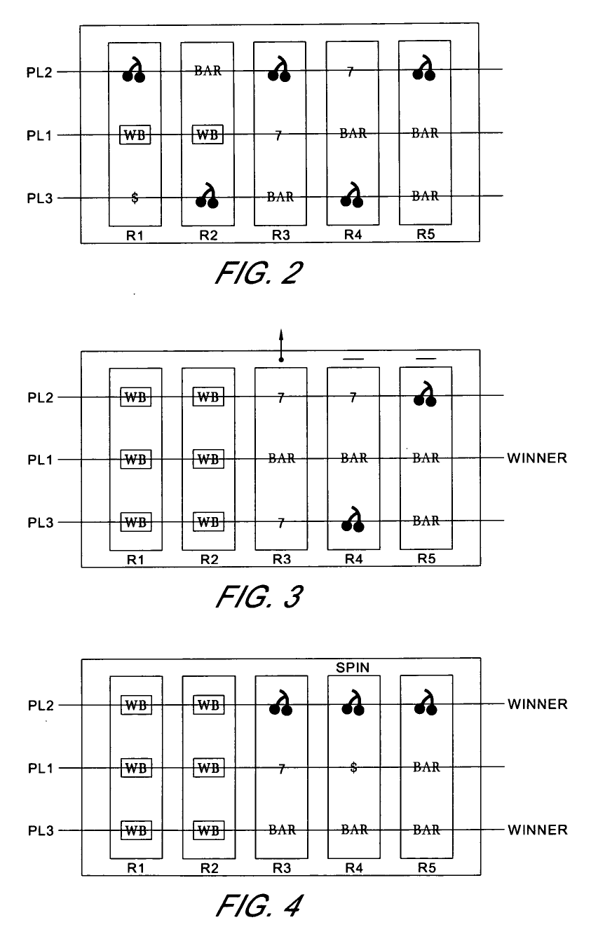

One example of the presentation/play of a game of the invention will be described with reference to FIG. 2. As illustrated, a gaming machine is configured to display a plurality of symbols. Those symbols may vary and may be associated with a theme. The symbols may be displayed via mechanical reels, a video display or otherwise.

In the embodiment illustrated in FIG. 2, three paylines PL1, PL2 and PL3 are designated. These paylines comprise horizontal lines corresponding to rows of symbol positions. As indicated herein, other paylines or payline configurations may be utilized. As indicated, a player may be required to place a wager of a certain size in order to “activate” the paylines. For example, by placing a minimum wager, payline PL1 may be activated and the player may be permitted to play the game. The player may be required to place a larger wager in order to activate the additional paylines PL2 and/or PL3.

The first set of symbols are generated and displayed to the player. One such set of symbols is illustrated in FIG. 2. In accordance with one embodiment of the invention, a winning result may be declared if the player receives one or more predetermined winning symbol combinations. The player may be paid winnings for those winning outcomes. In the example illustrated in FIG. 2, the player did not receive any such winning outcomes.

Further, in accordance with the game, if the player receives one or more special symbols in one or more locations, then the player is provided the opportunity to change or replace one or more other symbols in an attempt to obtain a winning outcome.

In one embodiment, if the special symbols appear on a first and a second of the reels/columns, such an opportunity is triggered. Such a situation is illustrated in FIG. 2 where in the player has received special “WB” (Win Builder) symbols on both the first and second reels R1,R2.

In one embodiment, in such a situation, the symbols associated with the reels on which the special symbols were received are treated as “wild” in that they may be treated as one or more different symbols. In addition, the player is provided the opportunity to change or replace one more of the symbols of the other reels.

In one variation of the game, the player may change the position of one or more of the other reels by one or more discrete positions in order to obtain a winning combination of symbols. FIG. 3 illustrates one embodiment where the player has been provided the opportunity to either maintain the positions of reels R3,R4,R5 or change the positions of the reels by one or more positions up or down. As illustrated in FIG. 3, the player has provided input requesting that the position of reel R3 be moved up by one position, with the position of the other reels maintained. In an embodiment where a winning result is five (5) of the same symbol, this selection has resulted in a winning combination along payline P1. In particular, the “wild” symbols on reels 1 and 2 are considered “Bar” symbols, and the symbols on reels R3-5 are “Bar” symbols, such that the player has received five (5) “Bar” symbols along payline P1. In that instance, a winning result is declared and the player is preferably awarded winnings.

In another embodiment of the game, as illustrated with reference to FIG. 4, the player may be permitted to change or replace symbols by “respinning” one or more of the reels R3-5, rather than just changing their position by one or more spots or positions. In the example illustrated in FIG. 4, the player has requested that reel R4 be respun to a new position. Again, in an embodiment where five (5) of the same symbols comprise a winning combination, then the player has received two winning results associated with paylines P2 and P3.

In one embodiment of the invention, the player may be provided the opportunity to provide input and effect more than one symbol change in sequential fashion. In a preferred embodiment, after making one input resulting in display of a second set of symbols, a player may make another input of changes resulting in display of a third set of symbols which determines the outcome of the game.

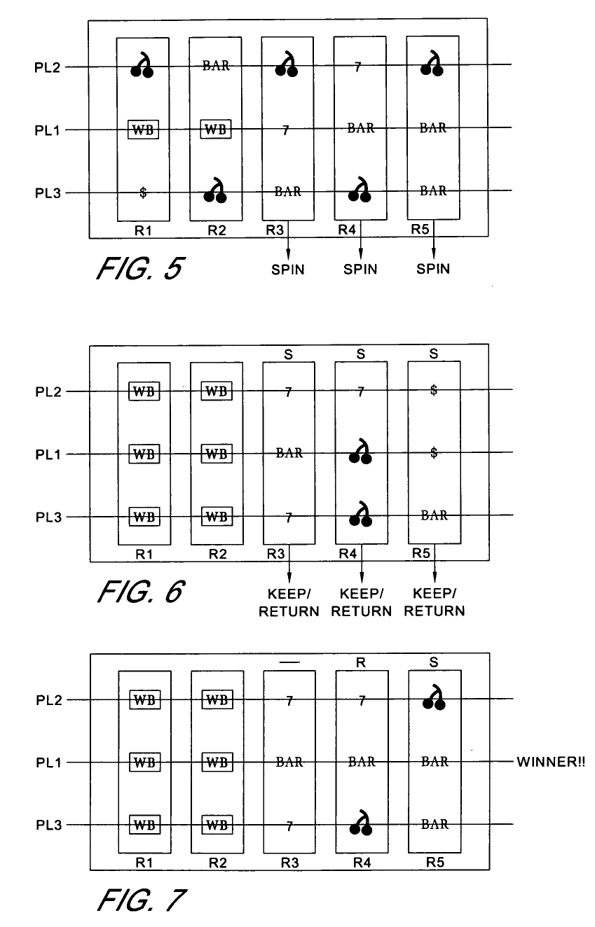

One example of this version of the game will be described with reference to FIGS. 5-7. Once again, a first set of symbols are generated and displayed to a player, such as in response to a player's wager and a game start input, such as depression of a “spin” button. Also, the resulting set of symbols is again evaluated to determine if any winning symbol combinations exist. If so, a winning result may be declared. The symbol set is also evaluated to determine if the requisite special symbols are displayed in the required positions, such as on the first and second reels.

FIG. 5 illustrates one set of displayed symbols. As illustrated, the player has received the special symbol WB on both reels R1 and R2. As such, in a preferred embodiment the symbols associated with reels R1 and R2 are treated as “wild” and the player is provided the opportunity to change one or more symbols of the other reels/positions in an attempt to generate a winning outcome. In one embodiment, the player is permitted to respin one or more of the remaining reels R3-5. In the example illustrated in FIG. 6, where the player has providing input requesting that all of these reels be respun, this results in a second set of symbols being displayed.

In accordance with this embodiment of the game, the player is now provided a second or subsequent opportunity to change the symbols of one or more of the reels R3-5. In one embodiment, the player may request return of each respun reel back to its original position. Thus, with respect to each of reels R3-5, the player must elect to maintain the position of the reel, respin that reel or move the reel back to its original position.

In the example illustrated, the player has elected to maintain the position of reel R3, return reel R4 to its original position, and spin reel R5. As a result of the spin of reel 5, the player has received a winning combination of symbols along payline PL1.

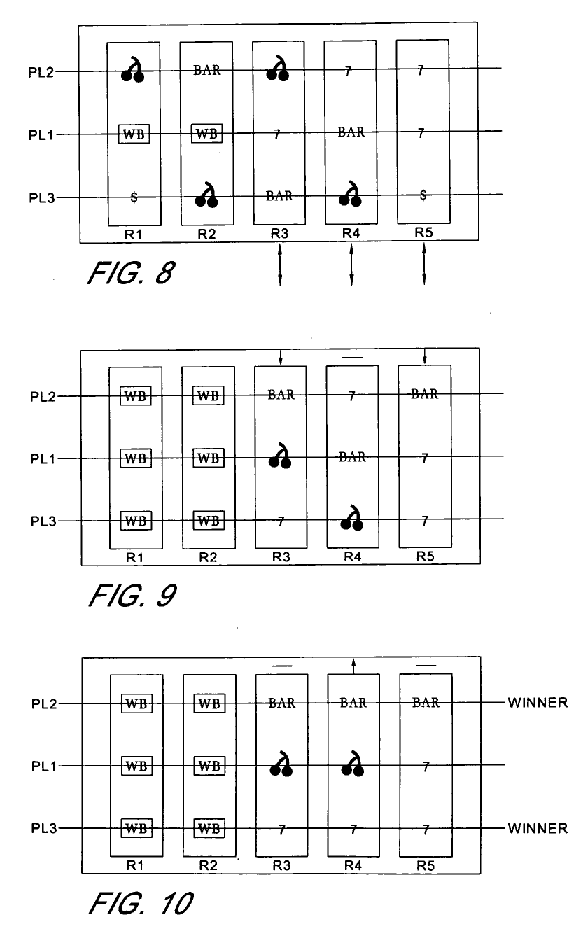

FIGS. 8-10 illustrate an embodiment of the invention where the player is again provided multiple sequential opportunities to change/replace symbols via discreet position changes. FIG. 8 illustrates the display of symbols like that described above relative to FIG. 5. Again, in this example, the player has obtained special symbols WB on reels R1 and R2, triggering the player opportunity to change/replace symbols in an attempt to form one or more winning combinations of symbols.

In this embodiment, the player is provided the opportunity to move the symbols by one or more discreet positions. When displayed in reel/column format, the player may be permitted to leave each reel in its existing position, move each reel up by one or more positions or move the reels down by one or more positions. In a preferred embodiment, the player can only move each of the reels by one position either up or down.

In the example illustrated in FIG. 9, the player has elected to move reel R3 down by one position, to maintain the position of reel R4, and move reel R5 down by one position. The player is then preferably offered a second opportunity to change symbols by changing the position of one or more of the reels. At this time, the player is afforded the opportunity to maintain the position of each reel, move each reel back to its original position (if it was moved), or change the position of each reel up or down.

In the example illustrated in FIG. 10, the player has elected to maintain the positions of reels R3 and R5 and has elected to move reel R4 up by one position. As a result of these selection, the player has received two winning combinations of symbols associated with paylines PL2 and PL3.

A variety of additional aspects and features of the invention will now be described. It will be appreciated that these aspects and features may apply to game as described above, including the various particular examples thereof.

First, in accordance with the invention, a player is offered the opportunity to replace, change or move one or more symbols based upon a triggering event. In the preferred embodiment, this triggering event is the receipt of one or more special symbols. The symbols may be “special” in that they are different from other symbols used to play the game, and are associated with the above-mentioned triggering event. The special symbols maybe located only on particular reels (such as on one particular reel or two or more particular reels) rather than all of the reels. In a preferred embodiment, the triggering event comprises the receipt of symbols on the first and second reels. The triggering event could comprise, however, the receipt of symbols on various of the reels. For example, referring to FIG. 11, in the case where symbols are displayed in a three-reel (whether in video format or by actual mechanical reels), the special symbol might only need to appear on a single reel, such as the first reel. In other embodiments, other of the reels/columns might be designated as the particular reels where the special or triggering symbols must appear (such as the two right-most reels).

In a preferred embodiment, the probability of the triggering event occurring is relatively low. Thus, for example, the number of special symbols or the probability of their display, may be relatively low (such as by limiting the number of special symbols associated with reel strips or associated with virtual positions of a video-simulated reel). In the manner, the frequency with which the opportunity for player input occurs may be limited to a sub-set of the number of games played. In a preferred embodiment, the game is preferably arranged so that the special symbol may be only received in the reels/columns which are required to trigger the special event (so that the player is not confused about whether receipt of the special symbol triggered the input event).

In one embodiment, the player may be required to receive the one or more special symbols or other triggering symbol combination in association with positions along an active payline. FIG. 2 illustrates such an example, where if payline PL1 is active, the special symbols WB have been received on the first and second reels along the active payline. In one embodiment, the special or other symbols associated with the triggering event do not need to be located along the same active payline, but may be located along any active payline. For example, referring to FIG. 2, in one embodiment if paylines PL1 and PL2 were active and the special symbols WB appeared on the first and second reels along either of these paylines, the event would be triggered.

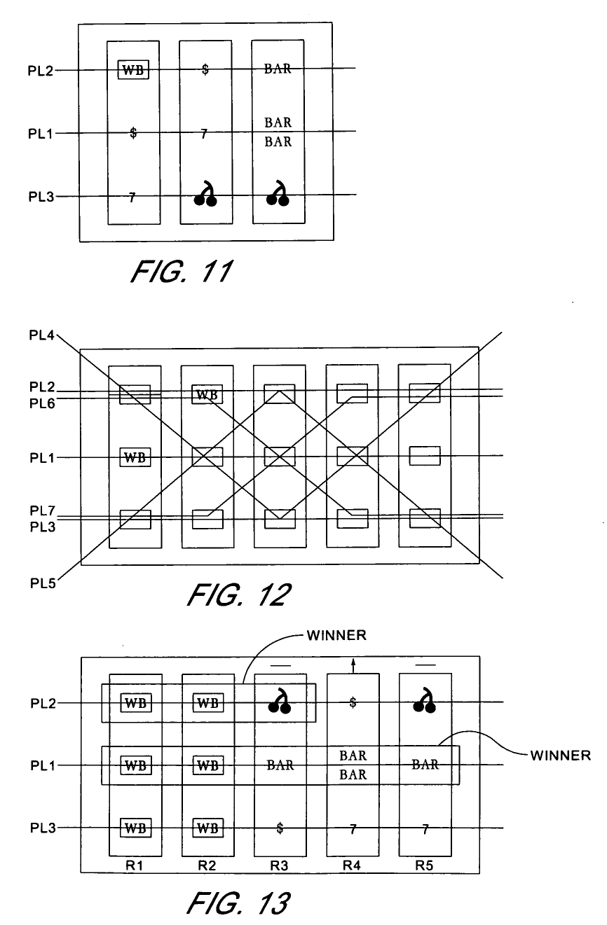

In another embodiment, the special symbols or triggering symbol combination need only be received relative to particular symbol positions, such as anywhere on the first and second reels. FIG. 12 illustrates such an embodiment where the special symbols WB have appeared anywhere on the first and second reels.

Preferably, the triggering event results in the symbols associated with one or more of the symbol positions turning “wild.” As indicated, in a preferred embodiment, all of the symbol positions of the first and second reels or columns with which the special symbols are associated may turn “wild.” This may be indicated by all non-special symbols of the first and second reels being transformed into special symbols (in the case of a video display), as illustrated in FIG. 3. In other embodiments, the symbols may be transformed or changed into other symbols, such as “WILD” symbols to clearly denote to the player the status of the symbols of these positions as “wild.”

Instead of having all of the symbols associated with the first and second reels (or other reels where the special symbols are displayed) all become wild, only the special symbols or other symbols which triggered the event may be treated as “wild.”

In the preferred embodiment, upon the triggering event, the player is permitted to change one or more of the symbols. In one variation, only non-wild symbols may be changed, and preferably, only those symbols associated with the other reels/columns. In the preferred embodiment, the player is permitted to change symbols either by moving the symbols in a particular direction by one or more positions, or by “respinning” the reels or otherwise randomly re-selecting symbols for the positions.

In a preferred embodiment, the player provides input or selection as to desired symbol changes, and the symbols are changed in response to the player's input. For example, the player might provide input via “spin” and “hold” buttons, via on-screen touch-menu items or other means. Of course, the particular inputs and their labeling may vary dependent upon the options presented to the player. For example, when presented with a first input, the player may be permitted to “spin” or “hold” the reels, and appropriate buttons or the like may be displayed to the player. When presented with a second input, the player may be permitted to “return,” “spin” or “hold” the reels and appropriate buttons or the like may be displayed to the player. Of course, game status and game instructions may be displayed or otherwise provided to the player at various times in order to aid the player in play of the game.

As illustrated in the figures, a visual indicator of the “status” of actions may be displayed. For example, after a player's first input, the status of each of the reels may be indicated to the player, such as by an “S” for a respun reel, arrows indicating previous reel position movement or the like. In this manner, player can confirm their inputs possible selections for subsequent inputs.

In an embodiment where a player is permitted to return symbols (such as reels/columns) back to an original position, the original symbol set/reel position may be indicated to the player. For example, such information may be displayed above or below the currently displayed symbol set. In this manner, the player can confirm the various possible symbol combinations which are available.

As indicated, in response to player input, the selected action is preferably accomplished. For example, upon receipt of a player input to spin a reel, the gaming machine is preferably configured to generate a new set of symbols and display those symbols for that reel/column.

In the case where the symbols are moved in one or more directions by one or more positions, the number of position changes may vary. In certain circumstances, the number of position changes may be randomly selected or may be dependent upon factors such as the size of a player's wager or receipt of particular game outcomes. For example, a player might place an additional wager in order to have the opportunity to move symbols by two rather than just one position. The player might also be provided the opportunity to move symbols by two rather than just one position if the player did not receive any winning symbol combinations after the first display of symbols.

In the examples illustrated, the symbols are associated with actual or simulated reels, and the symbol positions are changed up or down relative to a particular reel. The symbols might also be moved side to side or in other directions.

In the examples illustrated, the player may also “respin” the symbols associated with the actual or simulated reels. In the preferred embodiment, the “respin” comprises the selection of a new set of symbols for display in a particular selected column/reel. In the case of a mechanical reel, this may be by physical rotation of the reel. In the case of a video-based game, it may be by simulated video presentation of that event. It will be appreciated that in such a configuration, the new set of symbols which is displayed could comprise one or more of the same symbols which were selected to be changed (a mechanical reel could conceivably rotate and stop in the same position).

The player might also be permitted to randomly change or replace particular symbols or other groups of symbols. For example, the player might be permitted to select a certain number of particular symbol positions and have a random symbol selection effected, or rows of the symbols might be selected for replacement. Again, in this replacement process, the symbol positions are preferably randomly filled with symbols, thus providing the opportunity to receive different or even the same symbol(s) as was previously displayed.

The number of symbol changes may be limited. For example, a player may be permitted to change the symbols associated with all of the reels (other than the reels with which the special or other symbols which triggered the event were associated), or a certain number of or particular reels. The player might also be provided only a certain number of turns or tries to change the symbols.

As indicated, in a preferred embodiment, the player may be provided sequential opportunities (including two, three or more opportunities) to change symbols. The number of opportunities may be determined by the players wager. For example, by placing a larger bet, the player may be guaranteed two opportunities rather than just one. In one embodiment, the outcome of the game is determined when the player's opportunities have been exhausted. Thus, if after a first opportunity the player has received one or more winning combinations, the player may wish to not change the symbols as part of later opportunities, in order to not cause those winning symbol combinations to be destroyed.

As indicated above, in one embodiment winning combinations of symbols may be associated only with active paylines. The configuration of these paylines may vary. FIG. 12 illustrates a variety of examples of paylines for a 3×5 matrix of symbol positions. It will be appreciated that a variety of other payline configurations may be utilized.

In other embodiments, winning symbol combinations need not be located along specific paylines. For example “scatters” of symbols may result in a winning combination. For example, a player's receipt of a particular minimum number of the same symbols displayed anywhere (including the “wild” symbols) may result in a win.

A variety of winning combinations may be declared. In the examples illustrated in FIGS. 2-10, only combinations of five of the same symbol along an active payline comprised a winning combination. However, many other combinations of symbols might comprise winning combinations. For example, referring to FIG. 13, combinations of related but not identical symbols, such as BAR and BAR BAR symbols, of a certain minimum number, might be a winning combination. Lesser numbers of the same symbol, such as any three (3) CHERRY symbols in a row might comprise a winning combination.

In all cases, the player is afforded the opportunity to “build” off of a base of symbols, which symbols are preferably “wild” in order to try and obtain a winning combination of symbols. Thus, one aspect of the invention is a game providing a player the opportunity to strategize regarding actions to be taken to try and receive a winning combination.

A variety of advantages and features of the game will now be appreciated. One aspect of the invention is a slot-type game which offers player input. Another aspect of the invention is a game which affords the player the opportunity to “build” or generate a win by changing symbols, and most preferably, by changing symbols relative to one or more “wild” symbols.

Another aspect of the invention is a slot-type game where symbols associated with one or more reels are treated as “wild” upon occurrence of a triggering event, thus reducing the total number of remaining symbol positions which must be filled with particular symbols in order to gain a winning combination. Thus, not only is a player afforded the opportunity to change symbols in an attempt to transform a non-winning set of symbols into a winning set, but the player's probabilities of obtaining a winning result are raised by treating various of the symbols as “wild.”

The game may be presented in the form of a Class II type game or as part of such a game. It is known to play a Class II type game such as bingo and present the results of such a game as the outcome of a Class III type game. For example, based upon results of a Class II bingo game, a set of symbols as described above may be displayed to the player. That set of symbols may have a particular combination of winning symbols which corresponds to the outcome of the Class II game, thus representing the outcome of the Class II game in the format described above. The game may also be implemented as part of another game. For example, the game may be presented as a bonus event of another game. In such event, the “wager” which is placed may be paid to play the entire game and upon certain circumstances, a bonus event may be initiated which comprises the display of the symbols and possible player input in the manner described above.

One embodiment of the invention is a gaming machine configured to present the game. In one embodiment, the gaming machine includes a controller and at least one display. The controller is configured to generate game information comprising data representing playing card and non-playing card symbols. The display is configured to display the symbols based upon the generated data. As indicated, the controller may be configured to receive input such as wager information and other player input. The controller is also configured to determine game results and, if appropriate, award winnings.

In another embodiment, the gaming machine may include a controller and one or more physical reels capable of displaying the game indicia. Preferably, the controller is configured to generate game information which is used to control the reels, including spinning of the reels and stopping of the reels in particular positions, such as in the manner described above in greater detail. Again, the controller may be configured to receive player input and award winnings.

As indicated above, the controller may be a single processing unit or device directly associated with the gaming machine, or may comprise one or more elements located remote from one another. For example, a main controller may be configured to generate game information which is routed to local game controllers.

The game may also be played in Internet and other distributed environments. For example, the game may be presented to a player at a home computer. In one embodiment, a player may access a website which is supported by a remote host server. The host server may generate game information which is transmitted to the player's computer for display.

The game of the invention may be played as a bonus event or as part of other games, and/or itself may include bonus events. For example, in one embodiment, the game of the invention may be played as a bonus event as part of one or more main games. In such event, a player may not be required to place a wager to be entitled to play the game, but may instead become entitled to play the game as a result of the play of a base game (which itself may require a wager in order to be played).

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A method of playing a game comprising the steps of:
accepting a wager;
displaying a first plurality of symbols in a plurality of symbol positions associated with one or more paylines;
determining from said first plurality of symbols if any combinations of symbols along one or more of said paylines comprise a winning combination of symbols;
declaring a winning result for any of said winning combinations of symbols; and
determining from said first plurality of symbols if one or more special symbols are present in particular positions of said symbol positions and if so:
treating the symbols of one or more of said symbol positions as wild;
permitting said player to selectively change the symbols displayed in one or more of said symbol positions; and
declaring a winning result for each combination of symbols including said symbols treated as wild, which is a winning combination of symbols.

2. The method in accordance with claim 1 wherein said symbol positions are arranged into a plurality of reel columns, each column containing a plurality of positions.

3. The method in accordance with claim 2 wherein said step of determining if said one or more special symbols are present comprises determining if at least one special symbol is located in at least a first of said reel columns.

4. The method in accordance with claim 2 including the step of treating all of the symbols in positions of at least one of said reel columns as wild.

5. The method in accordance with claim 2 wherein said step of permitting said player to selectively change the symbols comprises moving symbols displayed in one or more or said reel columns by a discrete number of positions up or down.

6. The method in accordance with claim 2 wherein said step of permitting said player to selectively change the symbols comprises randomly replacing the symbols displayed in all position of at least one of said reel columns.

7. A method of playing a game comprising:
accepting a wager;
displaying symbols in symbol positions, said symbol positions arranged into a plurality of reel columns, each reel column having the same number of rows of positions;
determining if the symbols displayed along one or more active paylines associated with particular symbol positions comprise one or more predetermined winning combinations and, if so, declaring a winning outcome for each such combination of symbols; and
determining if at least one special symbol is associated with at least one of said reel columns and, if so, initiating a player input event comprising:
treating all symbols associated with positions of the reel column with which the at least one special symbol is associated as wild;
permitting the player to change the symbols associated with positions of the one or more reel columns with which the one or more special symbols were not associated;
determining if the symbols displayed along one or more active paylines associated with particular symbol positions, including the symbols treated as wild, comprise predetermined winning combinations and, if so, declaring a winning outcome for each such combination of symbols.

8. The method in accordance with claim 7 wherein five reel columns are provided.

9. The method in accordance with claim 8 wherein said player input event is initiated if said special symbol is present in at least one position of a first and a second of said reel columns.

10. The method in accordance with claim 8 wherein said step of permitting said player to change symbols comprises receiving input from said player regarding selection of one or more of said reel columns to respin and respinning those reel columns.

11. The method in accordance with claim 8 wherein said step of permitting said player to change symbols comprises receiving input from said player regarding a selection of one or more of said reel columns to have the symbols in positions thereof changed up or down by one or more discrete positions.

12. The method in accordance with claim 7 including the additional step of providing said player a second opportunity to change the symbols associated with positions of one or more reel columns with which the one or more special symbols were not associated.

13. A method of playing a game comprising:
accepting a wager from a player;
displaying symbols in at least five reel columns, each reel column having at least three symbols;
determining if at least one special symbol is present in a first and a second of said reel columns and, if so:
treating the symbols of said first and second reel columns as wild;
accepting a first input from a player regarding one or more of the symbols of the remaining reel columns to be changed;
displaying a second set of symbols including changed symbols; and
determining if said second set of symbols contains any predetermined winning symbol combinations.

14. The method in accordance with claim 13 wherein said first input comprises a selection to move the symbols of one or more reel columns up or down by one or more discrete positions.

15. The method in accordance with claim 13 wherein said first input comprises a selection to randomly replace the symbols of one or more reel columns.

16. The method in accordance with claim 13 including accepting a second input from a player regarding one or more of the symbols of the second set of symbols to be changed.

17. The method in accordance with claim 16 wherein if said first input comprises a selection to move the symbols of one or more reel columns up or down by one or more discrete positions, said second input comprises a selection to move previously moved symbols back to their original position or to move the symbols of one or more reels columns up or down by one or more discrete positions.

18. The method in accordance with claim 16 wherein if said first input comprises a selection to randomly replace the symbols of one or more reel columns, said second input comprises a selection to move change replaced symbols with their original symbols or to randomly replace the symbols of one or more reel columns.
